(19) United States
(12) Patent Application Publication
(10) Pub. No.: US 2025/0118115 A1
(43) Pub. Date: Apr. 10, 2025

(54) METHOD FOR RECORDING A NON-IMPACT EVENT OCCURRING WHILE DRIVING AND SYSTEM FOR THE SAME

(71) Applicants: HYUNDAI MOTOR COMPANY, Seoul (KR); KIA CORPORATION, Seoul (KR)

(72) Inventor: Kyoung Jun KIM, Hwaseong-si (KR)

(21) Appl. No.: 18/893,254

(22) Filed: Sep. 23, 2024

(30) Foreign Application Priority Data
Oct. 4, 2023 (KR) 10-2023-0131474

(51) Int. Cl. G07C 5/06; B62D 15/02; H04N 5/765

(52) U.S. Cl. CPC G07C 5/06; B62D 15/021; H04N 5/765

(57) ABSTRACT

Recording events of a vehicle with a steering angle sensor, a 3-axis accelerometer, and a vehicle speed sensor, and, more particularly, to a method of recording non-impact events while driving a vehicle and a system therefor, include determining whether a non-impact event has occurred based on signals sensed through the steering angle sensor, the 3-axis accelerometer, and the vehicle speed sensor of a running vehicle and recording and storing the non-impact event when the non-impact event is determined to have occurred.

### CROSS-REFERENCE TO RELATED APPLICATIONS

The present application claims priority to Korean Patent Application No. 10-2023-0131474, filed on Oct. 4, 2023, the entire contents of which is incorporated herein for all purposes by this reference.

### TECHNICAL FIELD

The disclosure relates to a method of recording non-impact events while driving a vehicle and a system therefor.

### BACKGROUND

An event data recorder (hereinafter, referred to as “EDR”), also known as a dashcam, is an apparatus that records videos of both inside and outside a vehicle while the vehicle is running or parked. The EDR serves as a tool for capturing footage before and after a collisions or other event, providing information to determine the circumstances of accidents.

The above-mentioned EDR was initially mounted only on the exterior of vehicles, but, nowadays, it is also built into vehicles before they are shipped.

The built-in EDR has been increasingly used because it is more useful than the external EDR in that it allows access to a host vehicle's driving data and connection with other controllers. For example, it checks the speed of the vehicle and whether the seat belts are worn, performs multiple functions including functions of a navigation system and Hi-pass (a system that allows drivers to make wireless toll payments in the expressways in South Korea), and generates a signal to request emergency rescue in an emergency situation.

In addition, the camera for obtaining videos with the external EDR only focuses on the front of a vehicle, but the built-in EDR provides various options of one channel (focusing on the front), two channels (focusing on the front and the rear), and four channels (focusing on the front, the rear, the left, and the right) according to a user's choice, i.e., the number of cameras. The multi-channel EDR is drawing much attention in consideration of autonomous driving.

Furthermore, the EDR records data on the speed of a vehicle, how a brake operates, engine rotation speed (RPM), accelerator pedal position, throttle valve operations, steering wheel angle, whether seat belts are worn, crash severity (Delta-V or acceleration), tire pressure, gear position, air-bag deployment data, etc.

Because the data of recorded videos is large, when a user has not selected a mode to store videos continuously for 24 hours, the videos obtained by the camera are temporarily stored for 15 seconds to 5 minutes using a buffer of the first in first out (FIFO) concept. When there is no event, the videos are not stored, and the temporary storage mode is maintained, so that videos obtained 15 seconds to 5 minutes prior to the current time, i.e., videos obtained up to 6 minutes prior to the time when an event has occurred, are not stored.

On the other hand, when an event occurs, the videos stored in the buffer are saved. Therefore, videos recorded 15 seconds to 5 minutes before the time of the event, videos recorded at the time of the event, and videos recorded after the time of the event are recorded and stored continuously.

Because the conventional EDR senses an impact exceeding a preset threshold in a vehicle and recognizes it as an event of the vehicle, it does not store videos of accidents where the vehicle has not been in contact with another vehicle (for example, accidents occurring to occupants of the vehicle due to avoidance of threatening (dangerous) driving from other vehicles) or an impact below the threshold has occurred.

In addition, even when a dangerous situation such as sudden acceleration or sudden braking of a vehicle occurs without an impact exceeding a threshold value, videos of such situations are also not saved.

### SUMMARY

The present disclosure is directed to a method of recording non-impact events while driving a vehicle and a system therefor, where it is determined whether a non-impact event that may occur in a driving vehicle has occurred based on changes in the steering angle of the vehicle, changes in the speed of the vehicle, changes in acceleration of the vehicle, etc., and the videos of the non-impact event is saved when the event is determined to have occurred.

According to one aspect of the subject matter described in this application, a method of recording non-impact events while driving a vehicle can include determining whether a non-impact event has occurred based on signals sensed through a steering angle sensor, a 3-axis accelerometer, and a vehicle speed sensor, and recording and storing the non-impact event when the non-impact event is determined to have occurred.

The determining of whether a non-impact event has occurred may further include determining that the non-impact event has occurred in response that an amount of increase in a speed of the vehicle sensed by the vehicle speed sensor based on a preset unit time is equal to or greater than a preset first threshold.

The determining of whether a non-impact event has occurred may further include determining that the non-impact event has occurred in response that an amount of reduction in a speed of the vehicle sensed by the vehicle speed sensor based on a preset unit time is equal to or greater than a preset second threshold.

The determining of whether a non-impact event has occurred may further include determining that the non-impact event has occurred in response that an amount of change in a steering angle sensed by the steering angle sensor is within a threshold range and a rotation of the vehicle is sensed by the 3-axis accelerometer.

The determining of whether a non-impact event has occurred may further include predicting a signal sensed by the 3-axis accelerometer based on signals sensed by the vehicle speed sensor and the steering angle sensor, comparing the signal predicted in the predicting with the signal sensed by the 3-axis accelerometer, and determining that the non-impact event has occurred according to a result of the comparing.

The determining of whether a non-impact event has occurred may further include determining that the non-impact event has occurred in response that a steering angle is outside a preset threshold range corresponding to a speed of the vehicle based on signals sensed by the steering angle sensor and the vehicle speed sensor.

The signal sensed by the vehicle speed sensor may be divided into a first section of 60 km/h to 70 km/h, a second section of 70 km/h to 80 km/h, a third section of 80 km/h to 90km/h, a fourth section of 90 km/h to 100 km/h, and a fifth section of 100 km/h to 110 km/h.

The preset threshold range may be in a range of 5° or less when the signal sensed by the vehicle speed sensor falls within the fifth section, in a range of 10° or less when it falls within the fourth section, in a range of 20° or less when it falls within the third section, in a range of 30° or less when it falls within the second section, and in a range of 35° or less when it falls within the first section.

The method may further include preventing the determining of whether a non-impact event has occurred from being performed according to a driver's selection.

According to another aspect of the subject matter described in this application, a system for recording non-impact events while driving a vehicle which comprises a camera video processing module that stores and manages videos obtained by at least one camera, an event sensing module that determines whether an event has occurred, and a recording module that records and stores the camera videos obtained by the camera video processing module according to an event signal generated by the event sensing module can include a steering angle sensor installed in the vehicle, a vehicle speed sensor installed in the vehicle, a 3-axis accelerometer installed in the vehicle, and a non-impact event determination unit configured to receive sensing signals output from the steering angle sensor, the 3-axis accelerometer, and the vehicle speed sensor to determine whether a non-impact event has occurred and drive the event sensing module in response that the non-impact event has occurred.

The non-impact event determination unit may determine that the non-impact event has occurred in response that an amount of increase in a speed of the vehicle sensed by the vehicle speed sensor based on a preset unit time is equal to or greater than a first threshold.

The non-impact event determination unit may determine that the non-impact event has occurred in response that an amount of reduction in a speed of the vehicle sensed by the vehicle speed sensor based on a preset unit time is equal to or greater than a second threshold.

The non-impact event determination unit may determine that the non-impact event has occurred in response that an amount of change in the steering angle sensed by the steering angle sensor is within a threshold range and a rotation of the vehicle is sensed by the 3-axis accelerometer.

The non-impact event determination unit may predict a signal sensed by the 3-axis accelerometer based on signals sensed by the vehicle speed sensor and the steering angle sensor, compare the predicted signal with the signal sensed by the 3-axis accelerometer, and determine that the non-impact event has occurred according to a result of the comparing.

Based on signals sensed by the steering angle sensor and the vehicle speed sensor, the non-impact event determination unit may determine that the non-impact event has occurred in response that a steering angle is outside a preset threshold range corresponding to a speed of the vehicle.

The signal sensed by the vehicle speed sensor may be divided into a first section of 60 km/h to 70 km/h, a second section of 70 km/h to 80 km/h, a third section of 80 km/h to 90km/h, a fourth section of 90 km/h to 100 km/h, and a fifth section of 100 km/h to 110 km/h.

The preset threshold range may be in a range of 5° or less when the signal sensed by the vehicle speed sensor falls within the fifth section, in a range of 10° or less when it falls within the fourth section, in a range of 20° or less when it falls within the third section, in a range of 30° or less when it falls within the second section, and in a range of 35° or less when it falls within the first section.

Through the method of recording non-impact events while driving a vehicle and the system therefor, it may be possible to store a video showing the reason why a driver has made an evasive maneuver or defensive driving while driving a vehicle as evidence even if there has been no impact when the driver has made such driving or sudden acceleration, sudden deceleration, wheel slip, etc. has occurred as a result of such driving.

### BRIEF DESCRIPTION OF THE DRAWINGS

FIG. 1 is a block diagram showing an example of components of an apparatus for recording videos for a vehicle for applying a method of recording videos of non-impact events while driving the vehicle.

FIG. 2 is a flowchart illustrating an example of process of recording non-impact events while driving a vehicle.

FIG. 3 is a diagram illustrating an example of a data table used in the process of recording non-impact events while driving a vehicle.

### DETAILED DESCRIPTION

A unit, a control unit, a control device, or a controller is a term widely used to name devices for controlling a certain function, and do not mean a generic function unit. For example, devices with these names may include a communication device that communicates with other controllers or sensors to control a certain function, a computer-readable recording medium that stores an operating system, logic instructions, input/output information, etc., and one or more processors that perform operations of determination, calculation, making decisions, etc. required to control the function.

Meanwhile, the processor may include a semiconductor integrated circuit and/or electronic devices that carry out operations of at least one of comparison, determination, calculation, and making decisions to perform a programmed function. For example, the processor may be any one or a combination of a computer, a microprocessor, a CPU, an ASIC, and an electronic circuit such as circuitry and logic circuits.

Examples of a computer-readable recording medium (or simply called a memory) may include all types of storage devices for storing data that can be read by a computer system. For example, they may include at least one of a memory such as a flash memory, a hard disk, a micro memory, and a card memory, e.g., a secure digital card (SD card) or an eXtream digital card (XD card), and a memory such as a random access memory (RAM), a static ram (SRAM), a read-only memory (ROM), a programmable ROM (PROM), an electrically erasable PROM (EEPROM), a magnetic RAM (MRAM), a magnetic disk, and an optical disk.

Such a recording medium may be electrically connected to the processor, and the processor may load and write data from the recording medium. The recording medium and the processor may be integrated or may be physically separate.

Hereinafter, a method of recording non-impact events while driving a vehicle and a system therefor will be described with reference to the drawings.

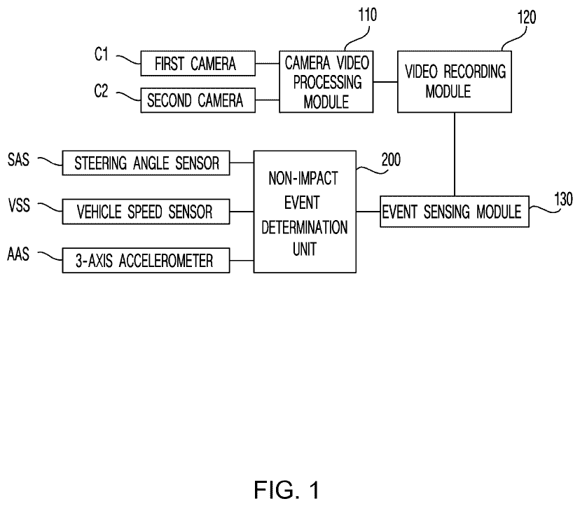

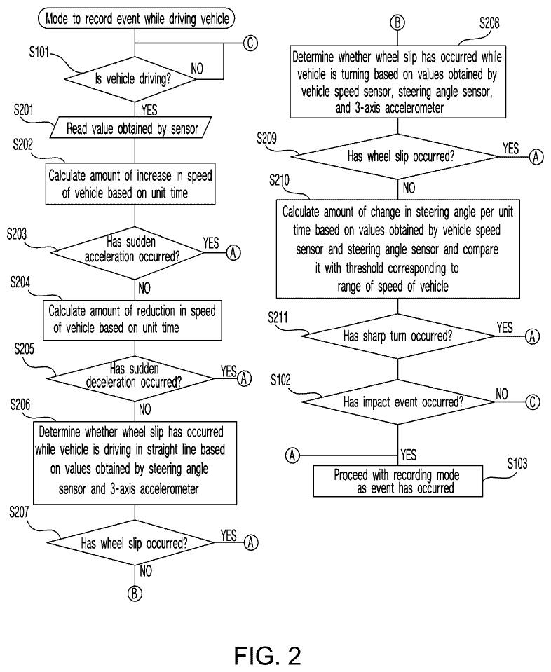

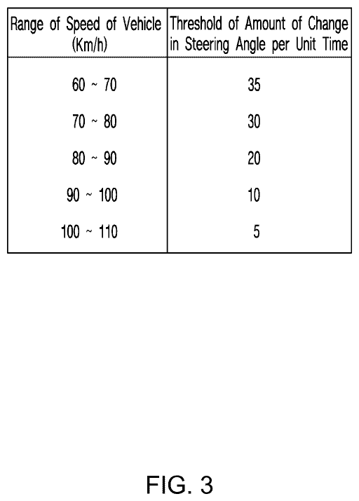

FIG. 1 is a block diagram showing an example of components of an apparatus for recording videos for a vehicle for applying a method of recording videos of non-impact events while driving the vehicle, FIG. 2 is a flowchart illustrating an example of process of recording non-impact events while driving a vehicle, and FIG. 3 is a diagram illustrating an example of a data table used in the process of recording non-impact events while driving a vehicle.

The components depicted in FIG. 1 can include at least one camera C1 and C2 built into a vehicle, a camera video processing module 110 that stores and manages videos obtained by the camera C1 and C2, an event sensing module 130 that determines whether an event has occurred, a steering angle sensor SAS that measures a steering angle, which refers to an angle at which the spindle of the steering wheel turns and moves when the vehicle changes the driving direction, a vehicle speed sensor VSS that measures the driving speed of the vehicle, a 3-axis accelerometer AAS with three acceleration sensors arranged along the three axes of spatial coordinates to measure the acceleration in the spatial coordinates applied to the vehicle, a non-impact event determination unit 200 that receives sensing signals output from the steering angle sensor SAS, the 3-axis accelerometer AAS, and the vehicle speed sensor VSS to determine whether a non-impact event has occurred and drives the event sensing module 130 when the non-impact event has occurred, and a video recording module 120 that records and stores camera videos obtained through the camera video processing module 110 based on event signals generated by the event sensing module 130.

It should be noted that the components referred to as a module or unit may include a memory storing a program to perform their respective functions and a processor executing the program and that the memory of each of the modules or units may be integrated into one or more memories and the processor thereof may be integrated into one or more processors.

The process of recording non-impact events while driving a vehicle with the vehicle components described above will be discussed with reference to FIG. 2.

At S101, when a user selects a mode for recording non-impact events while driving a vehicle, it may be determined whether the vehicle is currently driving, and, if so, the process may proceed to S201.

At S201, sensing signals output from the steering angle sensor SAS, the 3-axis accelerometer AAS, and the vehicle speed sensor VSS can be read.

Thereafter, at S202, the amount of increase in the speed of a vehicle sensed by the vehicle speed sensor VSS can be calculated based on a preset unit time (usually in seconds).

In some implementations, it may be determined at S203 whether the amount of increase in the speed of the vehicle calculated at S202 is equal to or greater than a preset first threshold. For example, when the amount of increase in the speed of the vehicle is equal to or greater than the preset first threshold, the event can be determined to have occurred due to sudden acceleration, and the process may proceed to S103.

At S103, the event sensing module 130 can be activated to generate an event signal, and the video recording module 120 can operate in a recording mode in response to the occurrence of the event according to the event signal generated by the event sensing module 130.

In some implementations, when it is determined at S203 that the event has not occurred due to sudden acceleration, the process can proceed to S204, and the amount of reduction in the speed of the vehicle sensed by the vehicle speed sensor VSS can be calculated based on the preset unit time (usually in seconds).

At S205, it can be determined whether the amount of reduction in the speed of the vehicle calculated at S204 is less than or equal to a preset second threshold. For example, when the amount of reduction in the speed of the vehicle is less than or equal to the preset second threshold, the event can be determined to have occurred due to sudden deceleration, and the process may proceed to S103.

In some implementations, when the event is determined to not have occurred due to sudden deceleration at S205, at S206, it may be check whether the rotation of the vehicle is sensed through the 3-axis accelerometer AAS when the vehicle drives in a straight line and the change in steering angle measured through the steering angle sensor SAS is within a critical range. For example, the critical range can be within 2° to 4°.

At S207, it may be determined whether wheel slip has occurred while the vehicle was traveling in a straight line based on the data obtained at S206. For example, when wheel slip occurs without the change in the steering angle by a drive, the vehicle may slide and turn in any direction, which can be sensed by the 3-axis accelerometer AAS.

Therefore, when it is determined at S207 that wheel slip has occurred while the vehicle was traveling in a straight line, the process may proceed to S103, and, when it is determined at S207 that wheel slip has not occurred while the vehicle was traveling in a straight line, the process may proceed to S208.

At S208, the signal sensed by the 3-axis accelerometer AAS can be predicted based on the signal sensed by the vehicle speed sensor VSS and the steering angle sensor SAS. The predicted signal can be compared with the signal that has been actually sensed by the 3-axis accelerometer AAS to determine whether the value is outside a preset allowable range.

For example, while a vehicle is turning, the acceleration applied to the vehicle can be calculated based on the driving speed and the steering angle of the vehicle, and, when wheel slip occurs, the turning angle becomes larger due to the centrifugal force of the turning vehicle, which increases the measured acceleration.

Therefore, at S209, it can be determined whether wheel slip has occurred based on the acceleration measured while the vehicle was turning, which has been calculated and compared at S208. When wheel slip is determined to have occurred while the vehicle was turning, the process can proceed to S103, and, when the wheel slip is determined to not have occurred while the vehicle was turning, the process can proceed to S210.

At S210, based on signals sensed by the steering angle sensor SAS and the vehicle speed sensor VSS, the measured speed of the vehicle can be compared with a preset threshold range of the steering angle corresponding to the speed.

FIG. 3 shows an example of the driving speed and the threshold range of the steering angle.

The signal sensed by the vehicle speed sensor VSS can be divided into a first section of 60 km/h to 70 km/h, a second section of 70 km/h to 80 km/h, a third section of 80 km/h to 90 km/h, a fourth section of 90 km/h to 100 km/h, and a fifth section of 100 km/h to 110 km/h.

The preset threshold of the steering angle can be in a range of 5° or less when the signal sensed by the vehicle speed sensor VSS falls within the fifth section, in a range of 10° or less when it falls within the fourth section, in a range of 20° or less when it falls within the third section, in a range of 30° or less when it falls within the second section, and in a range of 35° or less when it falls within the first section. In some implementations, when the output value of the steering angle sensor SAS is within the above-mentioned ranges per the respective sections, it can be determined that a sharp turn has not occurred.

In some implementations, when the value of the signal output from the steering angle sensor SAS is outside the critical ranges shown in FIG. 3, it can be determined that a sharp turn has occurred, and it can be determined at S211 that such a sharp turn that has occurred while the vehicle was driving refers that the driver of the vehicle is currently performing an evasive maneuver or a defensive driving.

The processes of S201 to S211 described above can be performed by the non-impact event determination unit 200.

It may be possible for the driver of a vehicle driving on a circuit or a track to stop the operation of the non-impact event determination unit 200 to prevent a phenomenon that inevitably occurs while a vehicle is driving on a circuit or a track from being recognized as a non-impact event.

What is claimed is:

1. A method of recording non-impact events while a vehicle is in motion, the method comprising:
determining whether a non-impact event has occurred based on one or more signals from a steering angle sensor, a 3-axis accelerometer, and a vehicle speed sensor; and
storing the non-impact event based on a determination that the non-impact event has occurred.

2. The method of claim 1, wherein determining whether a non-impact event has occurred includes determining that the non-impact event has occurred based on an amount of increase in a speed of the vehicle sensed by the vehicle speed sensor being equal to or greater than a preset first threshold, the speed of the vehicle being sensed according to a preset unit time.

3. The method of claim 1, wherein determining whether a non-impact event has occurred includes determining that the non-impact event has occurred based on an amount of reduction in a speed of the vehicle sensed by the vehicle speed sensor being equal to or greater than a preset second threshold, the speed of the vehicle being sensed according to a preset unit time.

4. The method of claim 1, wherein determining whether a non-impact event has occurred includes determining that the non-impact event has occurred based on (i) an amount of change in a steering angle sensed by the steering angle sensor being within a threshold range and (ii) a rotation of the vehicle being sensed by the 3-axis accelerometer.

5. The method of claim 1, wherein determining whether a non-impact event has occurred includes:
predicting a signal based on signals sensed by the vehicle speed sensor and the steering angle sensor,
comparing the predicted signal with a signal sensed by the 3-axis accelerometer, and
determining that the non-impact event has occurred based on a result of the comparison.

6. The method of claim 1, wherein determining whether a non-impact event has occurred includes determining that the non-impact event has occurred based on a steering angle being outside a preset threshold range corresponding to a speed of the vehicle according to signals sensed by the steering angle sensor and the vehicle speed sensor.

7. The method of claim 6, wherein the signal sensed by the vehicle speed sensor is divided into a first section of 60 kilometers per hour (km/h) to 70 km/h, a second section of 70 km/h to 80 km/h, a third section of 80 km/h to 90 km/h, a fourth section of 90 km/h to 100 km/h, and a fifth section of 100 km/h to 110 km/h.

8. The method of claim 7, wherein the preset threshold range is (i) in a range of 5° or less based on the signal sensed by the vehicle speed sensor being within the fifth section, (ii) in a range of 10° or less based on the signal being within the fourth section, (iii) in a range of 20° or less based on the signal being within the third section, (iv) in a range of 30° or less based on the signal being within the second section, and (v) in a range of 35° or less based on the signal being within the first section.

9. The method of claim 1, further comprising stopping the determination of occurrence of a non-impact event based on input received from a driver.

10. A system for recording non-impact events while a vehicle is in motion, the vehicle comprising a camera video processing module configured to store and manage camera videos obtained by at least one camera, an event sensing module configured to determine whether an event has occurred, and a recording module configured to store the camera videos obtained by the camera video processing module according to an event signal generated by the event sensing module, the system comprising:
a steering angle sensor disposed at the vehicle;
a vehicle speed sensor disposed at the vehicle;
a 3-axis accelerometer disposed at the vehicle; and
a non-impact event determination unit, implemented using one or more computing devices, configured to:
receive one or more signals from the steering angle sensor, the 3-axis accelerometer, and the vehicle speed sensor,
determine whether a non-impact event has occurred, and
operate the event sensing module based on a determination that the non-impact event has occurred.

11. The system of claim 10, wherein the non-impact event determination unit is configured to determine that the non-impact event has occurred based on an amount of increase in a speed of the vehicle sensed by the vehicle speed sensor being equal to or greater than a first threshold, the speed of the vehicle being sensed according to a preset unit time.

12. The system of claim 10, wherein the non-impact event determination unit is configured to determine that the non-impact event has occurred based on an amount of reduction in a speed of the vehicle sensed by the vehicle speed sensor being equal to or greater than a second threshold, the speed of the vehicle being sensed according to a preset unit time.

13. The system of claim 10, wherein the non-impact event determination unit is configured to determine that the non-impact event has occurred based on (i) an amount of change in a steering angle sensed by the steering angle sensor being within a threshold range and (ii) a rotation of the vehicle being sensed by the 3-axis accelerometer.

14. The system of claim 10, wherein the non-impact event determination unit is configured to:
predict a signal based on signals sensed by the vehicle speed sensor and the steering angle sensor,
compare the predicted signal with a signal sensed by the 3-axis accelerometer, and
determine that the non-impact event has occurred based on a result of the comparison.

15. The system of claim 10, wherein the non-impact event determination unit is configured to, based on a steering angle being outside a preset threshold range corresponding to a speed of the vehicle, determine that the non-impact event has occurred.

16. The system of claim 15, wherein the signal sensed by the vehicle speed sensor is divided into a first section of 60 kilometer per hour (km/h) to 70 km/h, a second section of 70 km/h to 80 km/h, a third section of 80 km/h to 90 km/h, a fourth section of 90 km/h to 100 km/h, and a fifth section of 100 km/h to 110 km/h.

17. The system of claim 16, wherein the preset threshold range is (i) in a range of 5° or less based on the signal sensed by the vehicle speed sensor being within the fifth section, (ii) in a range of 10° or less based on the signal being within the fourth section, (iii) in a range of 20° or less based on the signal being within the third section, (iv) in a range of 30° or less based on the signal being within the second section, and (v) in a range of 35° or less based on the signal being within the first section.
